(19) United States
(12) Patent Application Publication
(10) Pub. No.: US 2020/0047886 A1
(43) Pub. Date: Feb. 13, 2020

(54) COMBINATION OF UNMANNED AERIAL VEHICLES AND THE METHOD AND SYSTEM TO ENGAGE IN MULTIPLE APPLICATIONS

(71) Applicant: Shelton Gamini De Silva, West Vancouver (CA)

(72) Inventor: Shelton Gamini De Silva, West Vancouver (CA)

(21) Appl. No.: 16/436,714

(22) Filed: Jun. 10, 2019

Related U.S. Application Data
(63) Continuation of application No. 15/025,245, filed on Mar. 28, 2016, now abandoned.

(30) Foreign Application Priority Data
Oct. 8, 2013 (CA) 2829368

(51) Int. Cl. B64D 5/00; G05D 1/10; G05D 1/00; B64D 47/08; B64C 39/02; H04L 29/08

(52) U.S. Cl. CPC B64D 5/00; G05D 1/104; G05D 1/0011; B64D 47/08; B64C 39/024; H04L 67/12; B64C 2201/122; B64C 2201/021; B64C 2201/143; B64C 2201/082; B64C 2201/126; B64C 2201/206; B64C 2201/024; B64C 2201/145

(57) ABSTRACT

Disclosed herein is an Unmanned Aerial Vehicle (“UAV”) capable of carrying modules of Sub Unmanned Aerial Vehicles (“Sub UAVs”). More particularly, a UAV may be capable of communicating via satellite and remote control technology, ejecting said Sub UAVs, flying in sequence in a coordinated manner with the Sub UAVs, and capable of engaging in multiple missions in high, medium, low altitude, and surface. Further, the Sub UAVs can be enabled to return back to the UAV after the mission is completed and be firmly secured to the flatbed of the UAV.

### FIELD OF THE INVENTION

This invention relates to a flatbed featured Unmanned Aerial Vehicle hereinafter called “Mother UAV” member capable of carrying modules of Sub Unmanned Aerial Vehicle members hereinafter called “Sub UAV” member securely fastened on the flatbed area of the Mother UAV. More particularly, the method and system that is capable of ejecting said Sub UAV members from the Mother UAV member wherein Sub UAV members autonomously fly in sequence in a coordinated manner with the Mother UAV member, and capable of landing in a specified location, also the method end system that the Sub UAV members are able to return back to the Mother UAV member, and be firmly secured on the flatbed of the Mother UAV member. Further, Mother UAV member comprises of a system that the Mother UAV member and Sub UAV members communicate with each other via satellite and remote control technology to send and receive command signals between said UAV members, also to communicate with moveable or un-moveable “Data Station” members for the purpose of operating and activating all electronic and mechanical components for said UAV members to fly and engage in specified missions. The present invention is specifically designed for multifunctional and multipurpose applications for civil, commercial and military purpose.

### DESCRIPTION OF THE RELATED ART

In accordance with the prior art, the unmanned aerial vehicles are not new to the industry. There are number of aircrafts that carry unmanned aerial vehicles that have been developed. These unmanned vehicles mostly carry explosives for military purposes, such as the modern torpedoes that have self-propelled weapons with an explosive warhead. The earliest recorded use of an unmanned aerial vehicle dates back to Aug. 22, 1849, when the Austrians attacked the Italian city of Venice with unmanned balloons loaded with explosives. Since that there are number of developments that have occurred. The first pilotless aircraft was built during and after World War 1 controlled by radio control techniques. Today, unmanned aircrafts are becoming beneficial, useful, a cost effective method for civil, commercial and military purposes in the aviation industry. The prospective benefits from Unmanned Aerial Vehicles are incredible, and this technology has the potential to revolutionize the entire world in the future. Small drones are already taking a place in the Arctic sky and other locations to observe wildlife and engage in some research in close proximity to locations where accessible. However, experts, governments and agencies emphasize that this needs to be developed not only for the use for military purpose, including commercial and civil purposes that effectively support operations in the Arctic and other regions where humans are unable to access. Nevertheless, none of these similar manned or unmanned aircrafts are able to perform multiple applications and engage in multiple missions. The present invention is invented substantially departing from prior concepts, design and art, which provides fast access to remote and complex areas where humans and other vehicles are unable to access and engage in multiple missions.

U.S. Pat. No. 4,379,553 Inventors Kennesaw Edward W. Caldwell, and Smethers, Rolllo G, Jr., Atlanta, dated Apr. 12, 1983, Assignee to Lockheed Corporation, Burbank Calif., “Transport Airplane” which disclose flatbed of air craft capable of carrying passengers or cargo such as intermodal containers or vehicles.

U.S. Pat. No. 6,056,237 Inventor Woodland Richard L. K., Victoria BC Canada, dated May 2, 2000, “SONOTUBE COMPATIBLE UNMANNED AERIAL VEHICLE AND SYSTEM” which disclose UAV and systems comprises an apparatus enabling very small, man portable, ballistically launched, autonomously or semi-autonomously controlled vehicle to be deployed.

U.S. Pat. No. 6,364,026 Inventor Doshay Irving, Calif. USA dated Apr. 2, 2002, “ROBOTIC FIRE PROTECTION SYSTEM” which disclose fire fighting system comprising a set of unmanned aircraft and manned control vehicle and fight control station.

Canadian Patent No CA 2721996, Present inventor De Silva, Shelton Gamini, British Columbia Canada dated November, 2010 “SATELLITE COMMUNICATION REMOTE CONTROLLED UNMANNED AERIAL VEHICLES”

Which disclose piloted helicopter or aircraft drop unmanned aerial vehicles to combat wildfires.

### SUMMERY OF THE INVENTION

The high demand in interests on future economic development in the Arctic entirely depends on a sound environment foundation. Scientists, and researchers recognize that there is a huge gap of knowledge and there is an urgency to close this gap prior to any development in the Arctic region. In addition, there are other major environmental disasters, such as oil spills in the Arctic, disaster assistance, especially for search and rescue, access to disaster areas to deliver food, water and medicine. Nevertheless, to engage in said multiple missions are absolutely challengeable and extremely costly, since each of these missions need specific actions, diverse equipment and human involvement.

The main object of the present invention is to provide an unmanned aerial vehicle, and a method and system for multiple applications by innovating a Mother UAV member which comprises of a combination of supportive modules of Sub UAV members, and operating system that is capable to engage in broad range of missions, specially to engage in the Arctic region to collect (1) scientific data, monitor change of climate, weather pattern, sea-ice melting, (2) measure air quality at high, mid and lower altitude, specially to measure methane and other toxic gases in the Arctic (3) observe wildlife, ecosystem, marine environment, (4) surveillance, patrolling, securing borders, (5) transport goods, pipeline inspection, observe oil spills, and clean up method, (6) Arctic drilling for core ice samples (scientific research), (7) search and rescue. In addition to the above missions the present invention is capable for the use as (8) remote ground data-collecting stations in the Arctic, (9) military missions, (10) combat Arctic oil spills.

It is another object of this invention that the Mother UAV member comprises of, Sub UAV members, and the method and system that the Mother UAV member is able to release Sub UAV members to a specified location, also receive said Sub UAV members back on the flatbed of the Mother UAV member and be secured firmly.

Another object of this invention is to provide a system that the Sub UAV members are ejected from the Mother UAV member and operates autonomously while communicating with each other means communicating with the Mother UAV member, other Sub UAV members and Data Station member via remote and satellite communication technology. The Ground Data Station member will be fully equipped with latest technology and employed with highly experienced staff and experts who are able to comply on any challengeable mission.

Another object of the present invention is to provide a remote and satellite communication capability wherein, the Mother UAV member receives and transmits command signals between Data Station member, between Sub UAV members, whereby all Mother UAV and Sub UAV members communicates, operates and functions according to command signals received from each other.

Further, object of the present invention is to provide a system that the Sub UAV members are capable of storing collected data from a specific location and transmits said data to the Main UAV member immediately or at a later time. The basic principle is to collect data, store data and transmit collected data via satellites to the Data Station members to analyze and use for various purposes. Storing the data is one of the most important feature of the Sub UAV system, because when satellites are unable to obtain data at a specific time, due to weather, location of the satellites, distance where data is collected, or any other reason, the Sub UAV members are able to collect said data, store and transmit to the satellites when they are ready to receive. This will solve todays' issues of obtaining a steady stream of satellite data. It is important to note that, the Main UAV member is also able to receive accurate data from the Sub UAV members while flying at a selected altitude in the area.

Further, object of the present invention is that Sub UAV members are capable of landing on melting sea-ice and obtain data from under water submarines regarding thickness of the ice, melting pattern and sonar ice draft profile data etc. and transmits to Mother UAV member and to the Data Station member.

Still another object of the present invention is to provide a remote and satellite communication capability wherein, the Mother UAV member receives and transmits command signals between Data Station members, between Sub UAV members, whereby the Sub UAV members are capable of receiving command signals assembly from Mother UAV member and Data Control Station member so that the Sub UAV members are able to fly in a sequence and coordinated manner alongside the Mother UAV, and capable to maneuver and perform a specific action.

Further, object of the present invention is to provide a firm, safe and secure Sub UAV releasing and receiving system and mechanical locking system, wherein Mother UAV member is able to eject and receive Sub UAV members at high, low or mid altitude, while minimizing any accident and damage to any of said UAV members.

It is another object of the invention to provide a system to carry a cluster of mini unmanned vehicles inside the Sub UAV member that the mini unmanned vehicles are able to eject from the Sub UAV member and approach at close proximity of wildlife, wherein these mini unmanned vehicles are able to blend with birds, animals or other wildlife and obtain images and necessary information from special cameras and sensors. The Mini Unmanned Vehicles also comprise with a system that after collecting necessary data and samples return back to the Sub UAV member.

Another object of the invention is that the Sub UAV members are ejected from the Mother UAV members and lands on the ice or middle of the ocean or any appropriate location, and has the capability to move from one location to another where data needs to be collected. Once it lands, the hover engines will turn upright and provide power to move the Sub UAV member from one location to another as an unmanned hovercraft. This provides an opportunity to find a specific location that needs to be investigated, also allowing transporting any samples to near by data stations. It is important to note that these vehicles are designed for use in onshore and offshore by modifying the Sub UAV to change into a hovercraft capable of travelling over ice, water, land or mud.

Still another object is to construct the Sub UAV member with special padded interior walls to maintain appropriate temperature to protect instruments and equipment from extreme cold weather to keep them in proper working condition.

Further, present invention provides a combination of operating systems wherein Mother UAV member to be operated with jet engines so that said vehicle is able to approach a remote destination in a fast-moving manner, and the Sub UAV members consists with rotor system similar to helicopters and hover system, which is capable of vertical takeoff and landing. This combination of the unmanned vehicle system provides access to remote areas in a speedy manner where other vehicles and humans are unsuccessful. The present invention further comprises a method that the said UAV members be powered by solar, wind and battery technology.

To achieve the above object the present invention provides the Mother UAV member, which consists of a high nose structure in the front section, and a platform or flatbed structure in the back, which consists with a narrow front and wider back space wherein, the flatbed area has flexibility to carry a number of Sub UAV members.

In accordance with the invention thereof, the top section of flatbed area consists with concave sections, which has mechanical locking systems that the Mother UAV member is able to carry different size and payload capacity Sub UAV members at a one given time. When Mother UAV member needs to carry several sub vehicles, the concave sections of the flatbed area will automatically interchange and adjust the locking system to accommodate, such requirements. When Mother UAV member needs to carry different payloads the concave area and locking system assembly would change into a specific size and payload and so on.

Further, the present invention provides fixed wings connected to both sides of the flatbed area, also a pair of horizontal stabilizers and vertical stabilizers that extends from the end of the flatbed area. The Mother UAV member operates with turbine engines, which provides a high-speed capacity, which are mostly located under the wings, and it is important to note that these engines may be located in a different location based on specific requirements, especially to be used for military purpose to gain high velocity. However, these changes are within the spirit and scope of the present invention. Jet engine of the Main UAV member is designed varying in sizes, shapes and wing configurations. Further, provides that the jet engines to be rotated upwards for vertical takeoff and landing, this configuration also supports the Mother UAV member to be more stable and controlled in mid air during releasing and receiving Sub UAV members.

In addition, comprises of landing gears and all other necessary equipment, mechanical components and electronic components, to function and operate the Mother UAV member.

The Sub UAV member consists of a more different structure and operating system than the Mother UAV member. The external configuration of the Sub UAV member remains unchanged, and inner structure of the Sub UAV member changes according to a specific application. For example, when said Sub UAV member is used to combat oil spills the Sub UAV member would be constructed with the ability to carry booms or fire retardant substance. When said Sub UAV member is used for Arctic drilling it would comprise with a complete mechanical system and so on. The Sub UAV member operates with two operating modes, the rotorcraft in which lift and thrust are supplied by rotors similar to the helicopter, also comprises of a hover operating capability wherein Sub UAV member is able to easily land on the ground or water, and move from one location to another. On the other hand hover engines also assist for careful landing capability on the flatbed of the Mother UAV member when it returns.

It should be understood however, that this detailed description, while indicating preferred embodiments of the invention, is given by way of illustration only since various changes and modifications within the spirit and scope of the invention will become apparent to those skilled in the art.

### BRIEF DESCRIPTION OF THE DRAWINGS

FIG. 1 is a top view of the Mother UAV member carrying three Sub UAV members on the flatbed.

FIG. 2 is a view of the satellite communication system between the Data Station, Mother UAV member, Sub UAV members, and Moveable Data Stations.

FIG. 3 is a view of the Sub UAV member showing the rotor and hover engines attached to the Sub UAV member.

FIG. 4 is a view of the slightly liftoff of the Sub UAV members from the flatbed member of the Mother UAV member.

FIG. 5 is a view of the Sub UAV landing on the surface and the hover engines are in the upright position for the purpose of moving the Sub UAV from one location to another.

FIG. 6 is a view of the Sub UAV member on melting sea-ice or the ocean and obtains data, from underwater submarines regarding thickness of the ice; melting pattern and sonar ice draft profile data and more.

FIG. 7 is image of Sub UAV member carrying a number of Mini Unmanned Vehicle members that would be deployed in close proximity of wildlife areas, so that these mini vehicles are able to blend with birds, animals or other wildlife.

FIG. 8 is a view of the Mother UAV member 11 on how it controls the Sub UAV members so that the Sub UAV members are able to fly in a sequence and in a coordinated manner alongside the Mother UAV member.

### DETAILED DESCRIPTION

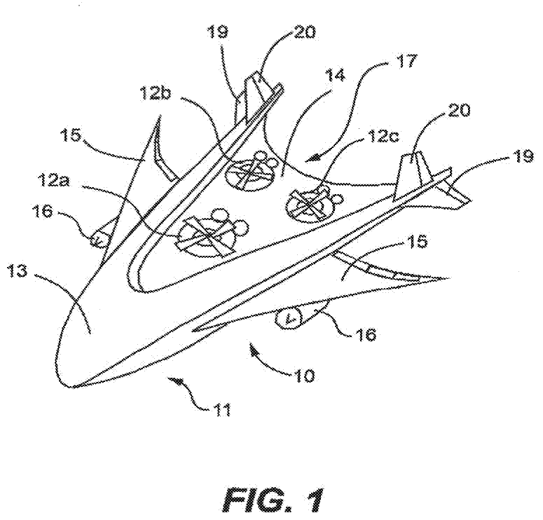

In particular to the drawings FIGS. 1-8, illustrates the Mother UAV member that carries modules of Sub UAVs generally designed by the reference numerical 10. Reference more particularly to the drawings 10 describes the top view of the Mother Unmanned Aerial Vehicle “Mother UAV” member 11, consists of a high front nose section member 13, and wider back section with flatbed surface member 14, which carries Sub UAV members 12A 12B and 12C. Further, comprises of a method and system that the Mother UAV member 11 is able to eject the Sub UAV member 12 in mid air, so that said Sub UAV member 12 is able to operate autonomously and land on a specified area and engage in a specific mission. Further, consists of a system and method that said Sub UAV member 12 is capable to return to the Mother UAV member 11 and land on the flatbed area member 14. In addition, includes wing members 15 on each side of the Mother UAV member 11, mounted with jet engine assemblies member 16 with the Tilt Rotor system, that is capable of hover, take off and landing. This provides a greeter flexibility and safety operation method of ejecting and receiving Sub UAV member 12 from and to the flatbed member 14 respectively. It is important to note that the main objective of present innovation is designed for use of multifunction multipurpose missions for various applications, the wings member 15, and engine member 16 may be modified and vary in shapes, size and configurations, and placed in different locations of the Mother UAV member 11. For example: for military use, high speed jet engines that will be able to gain high velocity may be mounted on the back of the Mother UAV 11 member etc., such modifications will be achieved only within the spirit and scope of the present invention. As illustrated in FIG. 1, the flatbed consists of a narrow front member and wider back section member 17, this is especially designed to create the necessary space to carry various sizes of Sub UAV members 12, and to provide sufficient space to maneuver and eject, and receive and land on the flatbed area member 14 to minimize hazards that pose a threat to any of the Unmanned Arial Vehicle member 11 and member 12. The Mother UAV member 11 further consists of multiple wheels member 18 mounted at the bottom of the Main UAV member 11, also pair of horizontal stabilizes member 19, and vertical stabilizer member 20 extends from end of flatbed 14.

In order to hold the Sub UAV members 12, securely on the flatbed area member 14, further provides a unique mechanical locking system wherein when Sub UAV member 12 is loaded or lands on to the flatbed member 14, the Sub UAV member 12 drops into a concave area and locks in firmly with a secure mechanical system. Also when Sub UAVs are ready to be ejected the mechanical locking system to be released safely and securely so that none of the Unmanned Vehicles face a hazard situation. Further, comprises with the system and method that the concave area for the locking system is able, to be adjusted and fitted to carry number of Sub UAV members 12. This will be achieved by mechanically changing the concave area according to size, payload and number of Sub UAV member or members carried on the flatbed member 14. For example: the Mother UAV member 11 needs to carry three Sub UAV members 12, the concave of the flatbed area will adjust to three concave spaces, and when Mother UAV member 11 needs to carry one Sub UAV member 12, the concave area adjusts as one concave area. This system would provide flexibility to carry number of Sub UAV members 12, especially to combat Arctic oil spills and wildfires.

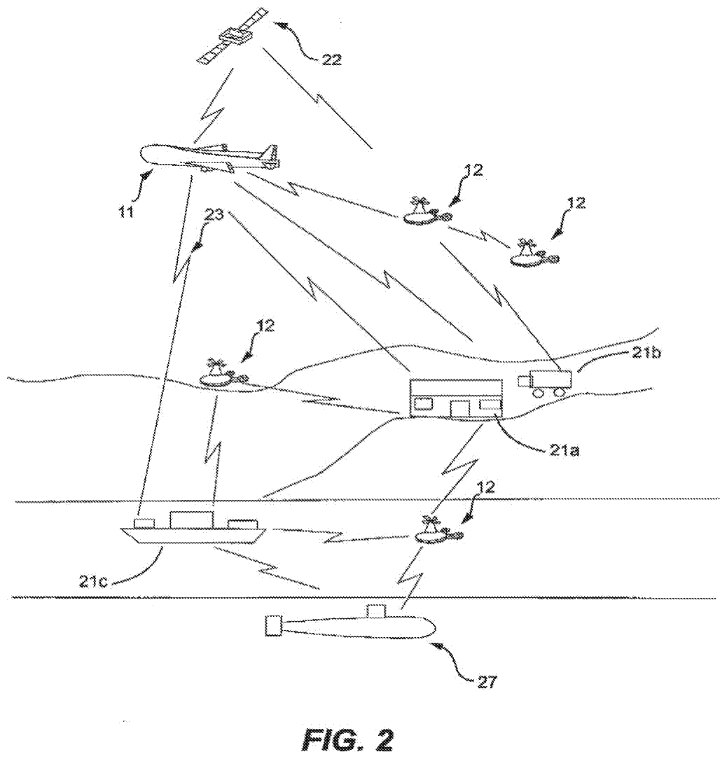

The mechanical locking system will operate based on command signal assemblies received from the satellite communication data station member 21 via satellite 22. As illustrated in FIG. 2, when Mother vehicle member 11 receives the command signal assembly 23, the Mother Vehicle member 11 unlocks the mechanical locking system wherein the Sub UAV member 12 is able to lift off from the concave area of the flatbed member 14, and ejects safely and systematically. In the same manner, when Sub UAV member 12 returns to the Mother UAV member 11, the Sub UAV member 12 lands extremely carefully on the flatbed area member 14 and secures firmly.

The module of Sub UAV member 12 is the most important unit of the present innovation. Since these are the vehicles deployed to remote and complex areas to obtain scientific data, combat oil spills, military and other missions. The outer configuration of Sub UAV members 12 maintains similar structure. However, the interior configuration would be changed to accommodate according to a specific application. For example, when a Sub UAV member 12 needs to be deployed to monitor change of climate or sea-ice, the interior of the Sub UAV member 12 is attached with specific cameras, sensors, and other necessary equipment. The Sub UAV members used to combat oil spills, the interior of the vehicle would consist with sufficient space to hold booms or fire retardant substance, when the Sub UAV member 12 is used for Arctic drilling for scientific data the Sub UAV member 12, would be equipped with a mechanical system etc.

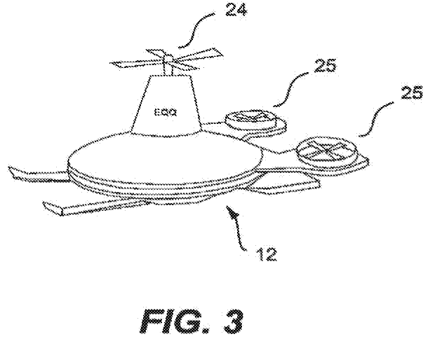

As illustrated in FIG. 3, the Sub UAV member 12 operates with a combination of a rotor system similar to the helicopter and hover fan technology wherein Sub UAV member 12 is capable of hover, takeoff and land vertically. The horizontal rotor blade 24 provides vertical lift, and hover fans 25 provides to pull against torque reaction and holds the Sub UAV member 12 straight. It is important to note that hover fans 25 will turn to various angles to provide such pull against torque.

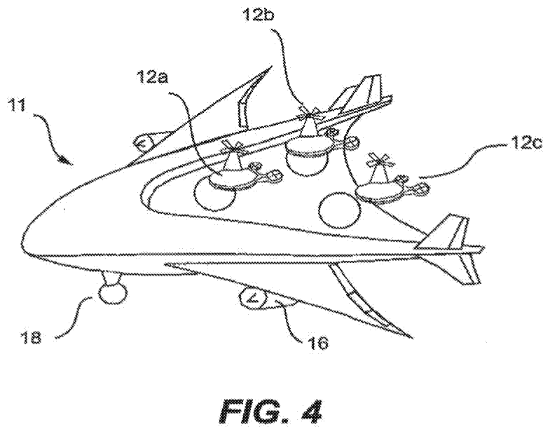

As illustrated in FIG. 4, when a Sub UAV member 12, is ready to eject, the hover engines will start and provide sufficient power to liftoff the Sub UAV member 12 slowly and systematically from the flatbed member 14, maintaining the balance of Mother UAV member 11 so that it wont cause any risk where UAVs would crash. At which time, all electronic locking systems releases the Sub UAV members 12, and once the Sub UAV member 12 is ejected, it lifts off and moves away from the Mother UAV member 11, the horizontal rotor system 24 turns ON and takes over the Sub UAV member 12 operating system, similar to the helicopter. All these changes of operating systems take place in air with extreme balance so that speed of each of horizontal rotor blades 24 and hover fans 25 are able to control Sub UAV member 12 and operate in a safe manner. This combination of operating system will provide Sub UAV members 12 to approach far locations faster and the hover fan operating system to land vertically and maneuver at a high, in mid and low elevation while descending, and collect highly important scientific data such as methane and other toxic releases in the Arctic. This will solve today's priority issue of how to collect scientific data of methane and other toxic gases in the Arctic region where humans and other vehicles are unable to access. This is one of the highest priorities at the moment in the Arctic.

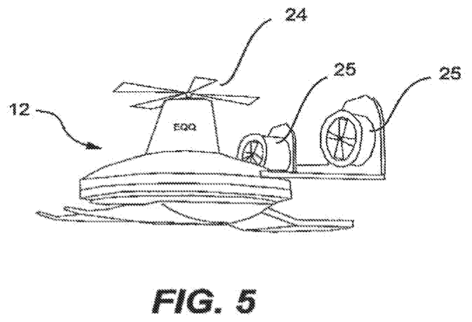

Present innovation comprises of a unique design that allows Sub UAV member 12 to operate in both land and water. As illustrated in FIG. 5, once the Sub UAV member 12 lands on the ground or ocean, the hover engine 25 turns upright and provides power to move the Sub UAV member 12 from one location to another as an unmanned hovercraft. This creates capability to find a specific location that needs to be investigated or access to specific areas where aircrafts, boats or humans are unable to access. Further, provides the opportunity to transport samples of scientific information, food, water and medicine to people in disaster areas, also rescue people in the Arctic, combat Arctic oil spills and in the clean up process.

As shown in FIG. 3, the Sub UAV member 12 consists with special padded interior walls to maintain appropriate temperature to protect instruments and equipment from the cold weather, and keep them in proper working condition. The Sub UAV member 12 is powered by solar, battery power, and fuel similar to the present techniques used in the industry, and specially creates a wind technology, that would turn the hover engine to generate the power. Since, the Sub UAV member 12 needs extreme power to operate in harsh weather conditions.

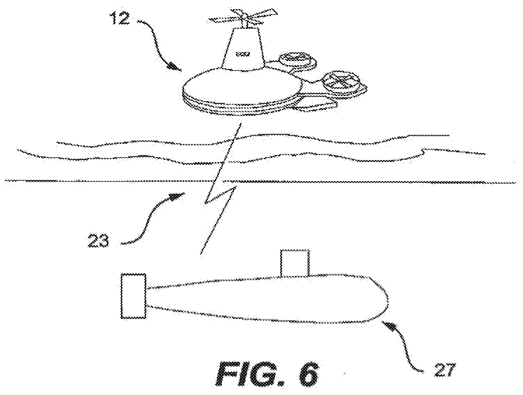

As illustrated in FIG. 2, present invention comprises with a system that the Mother UAV member 11 communicates with the Sub UAV member 12, Data Station 21, via satellite 22 to send and receive command signals wherein Mother UAV member 11 and all other Sub UAV members 12 and mini unmanned vehicle members 26 to operate and function, all necessary equipment, electronic components so that all UAV members 11, 12, and 26 are able to fly, collect data, store data, transmit data including engage in all the following missions, collect scientific data, monitor change of climate, weather pattern, sea-ice melting, air quality, observe wildlife, ecosystem, marine environment, surveillance, patrolling, securing borders, transport goods, pipeline inspection, observe oil spills, and clean up. Arctic drilling for core ice samples (scientific research), military applications, use as remote ground data collecting stations, combat Arctic wildfires, monitor Oil spills cleanup missions. As illustrated in FIG. 6, the Sub UAV member 12 also consists of a method, to land on melting sea-ice and obtain data, from underwater submarines 27 regarding thickness of the ice, melting pattern and sonar ice draft profile data and more. The Data Station member 21 will be fully equipped with latest technology and employed with highly experienced staff and experts who are able to comply on any challengeable mission. Further, the present invention is to provide a remote and satellite communication capability wherein, the Mother UAV member 11 receives and transmits command signals between Data Station 21, between Sub UAV members 12, whereby Mother UAV member 11 and Sub UAV members 12 communicates, operates and functions according to command signals received from each other.

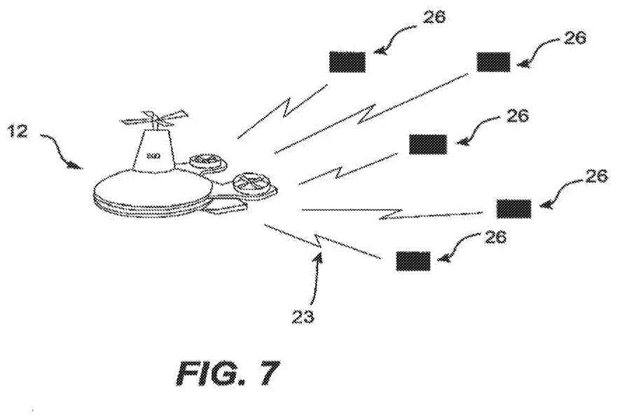

In order not to disturb wildlife in the Arctic region, as illustrated in FIG. 7, the Sub UAV member 12, is designed to carry a number of Mini Unmanned Vehicle members 26 that would be deployed in close proximity of wildlife areas, so that these mini vehicles are able to blend with birds, animals or other wildlife. These vehicles will obtain images and necessary information from special cameras and sensors, and transmit the data to the Sub UAV member 12 in-turn the Sub UAV member 12 will transmit collected data to the Data Stations 21 via existing satellites. The Mini Unmanned Vehicle members 26 also comprise with a system to collect plants and wildlife samples and return back to the Sub UAV member 12. It is important to note that this feature is within the scope of the present invention, since interior of the Sub UAV member 12 is designed to carry various substances and mechanical components based on specific missions.

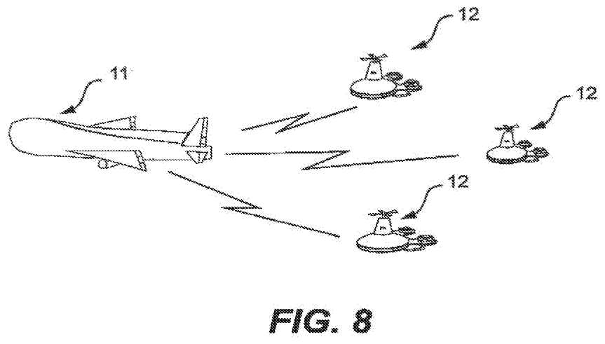

As illustrated in FIG. 8, also comprises of a method that the Mother UAV member 11 is capable of controlling Sub UAV members 12 whereby the Sub UAV members 12 are capable of receiving command signals from Mother UAV member 11 and Data Control Station 21 so that the Sub UAV members 12 are able to fly in a sequence and in a coordinated manner alongside the Mother UAV member 11, also capable of maneuvering and performing specific actions.

While, various embodiments have been described, it will be understood by those skilled in the art the variety of modifications and variations are possible, changes made and equivalents may be substituted for elements thereof without departing from the scope of the technique herein. In addition, may be made to adapt a particular situation to those techniques without departing from the essential scope thereof. Therefore it is intended that the scope of the claims set forth hereinafter not be limited to the disclosed embodiments.

What is claimed is:

1. An unmanned aerial vehicle (UAV), comprising:
a flatbed area on the exterior of the UAV configured to receive a plurality of other UAVs, wherein the flatbed area faces substantially upward while the UAV is in a flight orientation and wherein the flatbed area is dimensioned to enable another UAV of the plurality of other UAVs to land on the flatbed area while both the UAV and the other UAV are in flight;
a communications system configured to communicate with one or more of the plurality of other UAVs via satellite; and
a remote control system configured to send and receive command signals and/or communication signals to and from one or more data stations.
